(19) United States
(12) Patent Application Publication
(10) Pub. No.: US 2006/0176258 A1
(43) Pub. Date: Aug. 10, 2006

(54) Color cholesteric liquid crystal display device and manufacturing method for the same

(76) Inventors: Yi-An Sha, Taipei City (TW); Hsing-Lung Wang, Ping Jen City (TW); Chi-Chang Liao, Tai Nan City (TW); Chih-Chiang Lu, Hsin Chu City (TW); Jau-Min Ding, Taipei City (TW)

Correspondence Address: RABIN & BERDO, P.C.;Suite 500, 1101 14 Street, N.W., Washington, DC, 20005, US

(21) Appl. No.: 11/182,831

(22) Filed: Jul. 18, 2005

(30) Foreign Application Priority Data
Feb. 4, 2005 (TW) 94103639

(51) Int. Cl. G09G 3/36; G02F 1/1335; G09G 3/10; G02F 1/1333

(52) U.S. Cl. 345/88; 428/1.1; 349/88; 349/96; 315/169.3

(57) ABSTRACT

A color cholesteric liquid crystal display device and a manufacturing method for the same are proposed. A color cholesteric liquid crystal display device has a bistable single-layer or stacked structure. The display is made of cholesteric liquid crystal material via an inkjet process and ultraviolet exposure processes that induce a phase separation reaction. In addition, the display provided in the present invention enhances the reflective brightness. Furthermore, the techniques of the present invention can be applied to make flexible color cholesteric liquid crystal display devices.

### BACKGROUND OF THE INVENTION

1. Field of the Invention

The present invention is related to a color cholesteric liquid crystal display device and a manufacturing method for the same, and more particularly, to a color cholesteric liquid crystal display device with a bistable single-layer (or stack) structure. The display is made of cholesteric liquid crystal material via an inkjet process and two ultraviolet exposure processes. In addition, the display provided in the present invention has enhanced reflective brightness and is flexible.

2. Description of Related Art

In recent years, flexible displays, electronic papers and electronic books have been developed vigorously. The display media include liquid crystal displays, electronphoretic displays, electrochromic displays and electrolytic displays. In the application of electronic papers, compared with displays made of other display materials, the display made of a cholesteric liquid crystal material has higher brightness and better contrast. In addition, the cholesteric liquid crystal display can be driven passively and produced easily.

Conventionally, for manufacturing color cholesteric liquid crystal display devices, two methods are often used. The first one uses a cholesteric structure with three layers. By stacking three cholesteric liquid crystal layers capable of reflecting different colors and using various driving methods, the display can reflect various colors. Its drawback is that the alignment of the panel with the three-layer structure cannot be achieved easily and this kind of display can only be bent a little. The second one uses a cholesteric structure with a single layer only. It mixes a twist agent that can first be decomposed by light and a cholesteric liquid crystal material. Then, ultraviolet light with different intensities is used to destroy or reduce the twist agent located at a single area. Thus, a single-layer display capable of reflecting various colors can be provided. However, this device with the single-layer structure is unreliable. The environment affects it easily. Hence, this device needs to use an additional ultraviolet-proof layer for protection.

In the prior art, such as U.S. Pat. No. 6,356,323, a “Color display using cholesteric liquid crystals” is disclosed. Reference is made to FIG. 1, which is a schematic diagram of a structure of a conventional color cholesteric liquid crystal display device. The structure includes an absorbing surface 10, a clear flexible substrate 12, a first patterned ITO layer 14, a second patterned ITO layer 16, a third patterned ITO layer 18, a fourth patterned ITO layer 20, a fifth patterned ITO layer 22, a first light modulation layer 24, a second light modulation layer 26 and a third light modulation layer 28.

Furthermore, U.S. Pat. No. 6,331,884, “method of making a liquid crystal display,” discloses a method that uses a liquid crystal material to make a liquid crystal device. Reference is made to FIG. 2, which is a schematic diagram for showing the manufacturing process of the conventional liquid crystal device. The liquid crystal device has multiple liquid crystal materials 30, multiple precursors 32, a first base 34, a second base 36, multiple conductive films 38, multiple insulating films 40, multiple bank structures 42 and an absorbing layer 44.

However, the above method for making the liquid crystal display disclosed in U.S. Pat. No. 6,331,884 has a drawback. In the above method, a resin material must first be smeared on multiple insulating films 40. Then, multiple liquid crystal materials 30 are arranged by a printing process and a second base is placed thereafter. Lastly, an exposure process is provided to form multiple precursors 32. In this way, the thickness and manufacturing process of the display device is difficult to control. A higher driving voltage is required, and image effects thereof are poor.

### SUMMARY OF THE INVENTION

An objective of the present invention is to provide a color cholesteric liquid crystal display device with a bistable single-layer (or stack) structure. The display is made of cholesteric liquid crystal material via an inkjet process and ultraviolet exposure processes. In addition, the display provided in the present invention has enhanced reflective brightness and is flexible.

For reaching the objective above, the present invention provides a method for manufacturing a color cholesteric liquid crystal display device. Multiple bank structures are made on a first electrode layer of a lower base. A first solution is printed among the bank structures to form multiple first cholesteric liquid crystal layers, in which the first solution is a mixture of first cholesteric liquid crystal materials and first monomers. Multiple cover layers are formed on the first cholesteric liquid crystal layers. A second solution is printed onto the bank structures to form multiple second cholesteric liquid crystal layers, in which the second solution is a mixture of second cholesteric liquid crystal materials and second monomers. Multiple upper covers are formed on the second cholesteric liquid crystal layers. The upper covers are coated with multiple conductive materials.

The present invention provides a color cholesteric liquid crystal display device having a stacked structure. It includes an lower base having a first electrode layer; multiple bank structures distributed over the lower base; multiple first cholesteric liquid crystal materials provided among the bank structures; multiple cover layers coated on the first cholesteric liquid crystal materials; multiple second cholesteric liquid crystal materials provided on the cover layers; and multiple upper electrodes distributed on the cover layers.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a structure of a conventional three-layer color cholesteric liquid crystal display device;

FIG. 2 is a schematic diagram for showing the manufacturing process of a conventional liquid crystal device;

FIGS. 3A-E show a schematic diagram of a color cholesteric liquid crystal display device having a stacked structure in accordance with the first embodiment of the present invention; and

FIGS. 4A-E show a schematic diagram of a color cholesteric liquid crystal display device having a stacked structure and a dual-base structure in accordance with a preferred embodiment of the present invention.

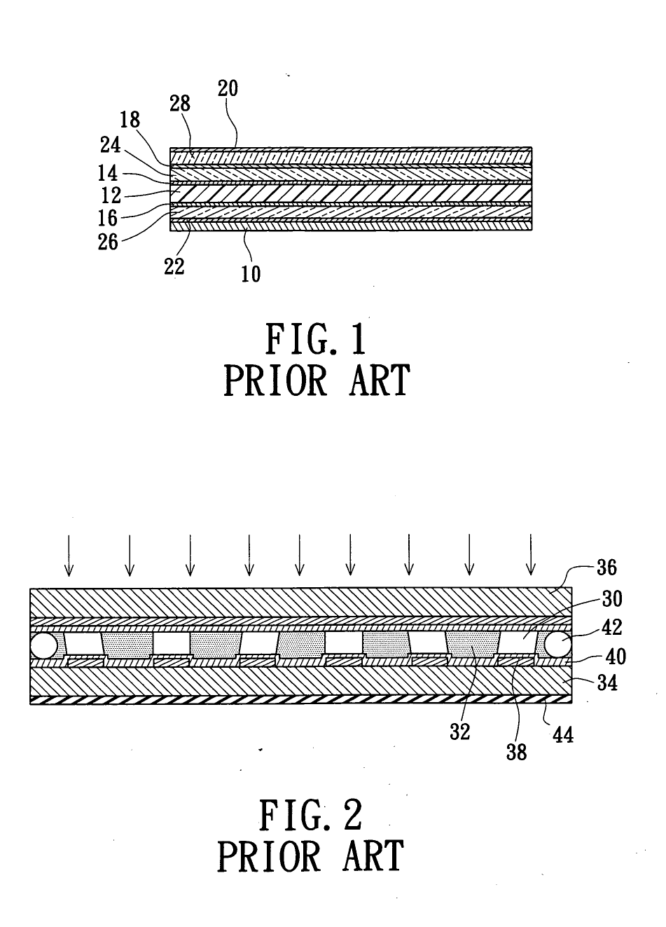

### DETAILED DESCRIPTION OF PREFERRED EMBODIMENTS

The prior art, such as U.S. Pat. No. 6,356,323, uses a conventional liquid crystal infusing method. The present invention uses an inkjet printing method to print the cholesteric liquid crystal materials with three colors on the defined display areas, and uses a phase separation processes to provide a color cholesteric liquid crystal display device with a single-layer structure or a stacked structure.

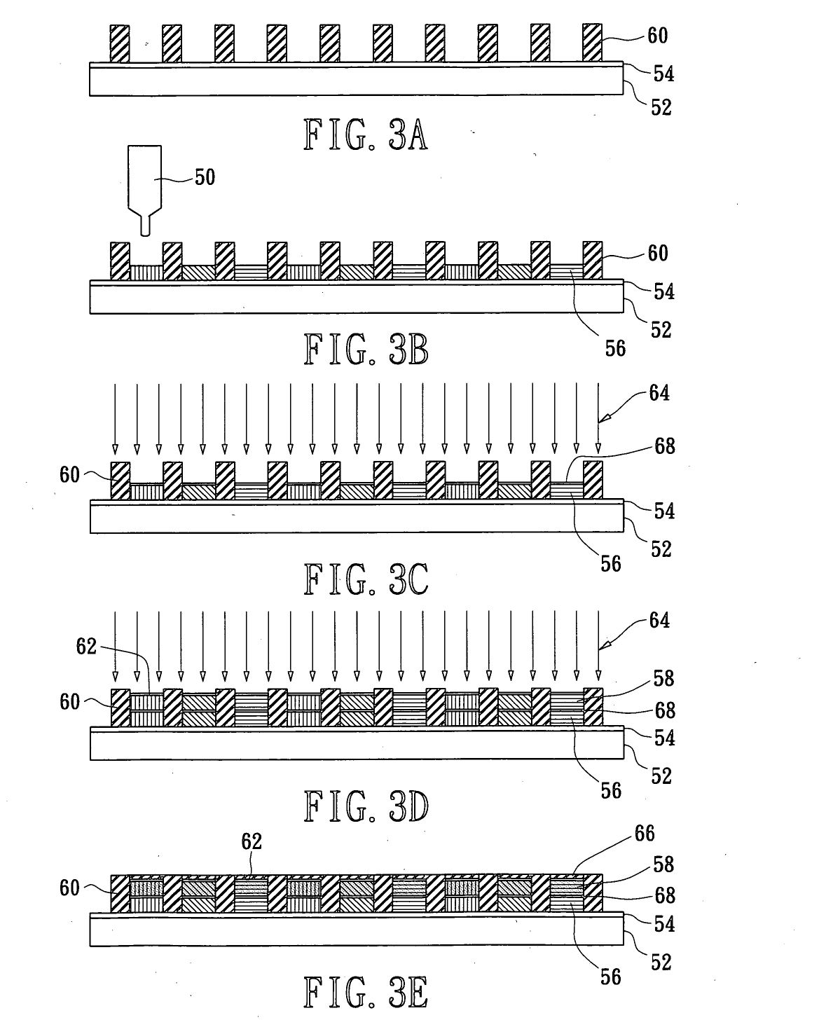

Reference is made to FIGS. 3A-E, which show schematic diagrams of a color cholesteric liquid crystal display device with a stacked structure manufactured via an inkjet printing process in accordance with the first embodiment of the present invention. In FIG. 3A, multiple bank structures 60 are provided on a first electrode layer 54 of a lower base 52. The foresaid lower base 52 can be a glass base or a plastic base. The first electrode layer can be made of an inorganic conductive material or an organic conductive material and includes an active or passive driving circuit. The bank structures 60 are provided via a lithography process, a die-casting process, a screening printing process and/or an inkjet printing process. The bank structures 60 can be made of a macromolecule material having a black pigment or dye.

In FIG. 3B, a first solution is printed among the bank structures 60 to form a solution layer 56. The above first solution is a mixture of multiple first cholesteric liquid crystal materials and monomers. The first solution is printed via a nozzle 50, i.e. via an inkjet printing process. The first cholesteric liquid crystal materials are cholesteric liquid crystals and/or nematic liquid crystals mixed with a twist agent. The first cholesteric liquid crystal materials can reflect multiple different colors. The first cholesteric liquid crystal materials can also reflect light with red, green and blue colors. The cholesteric liquid crystal materials further include a pigment or dye capable of reflecting visible light having a wavelength of 400-800 nm. The above first solution, the mixture of the first cholesteric liquid crystal materials and monomers, includes liquid crystals with different twisted features. Moreover, in the manufacturing process, an alignment layer is further coated on a first electrode layer of a lower base. The alignment layer is made of polyvinyl alcohol, polyimide, aramid, nylon, silica, micro-grooves or lecithin. When the step of printing the above first solution among the bank structures is completed, a single-layer color cholesteric liquid crystal display device is provided. It is thinner and has a simpler manufacturing process. Furthermore, the arrangement of the pixels of the single-layer cholesteric liquid crystal display device can have various combinative types of left-twisted and right-twisted features for increased reflectance.

In FIG. 3C, multiple bank structures 68 are formed in the solution layer (also called cholesteric liquid crystal layer). These bank structures are formed via ultraviolet exposure, which induces phase separation. In this step of the present invention, the device is directed exposed under ultraviolet light 64.

In FIG. 3D, a second solution that includes multiple second cholesteric liquid crystal materials and monomers is printed onto the cover layers to form a solution layer. The second solution is printed via a nozzle 50, i.e. via an inkjet printing process. The second cholesteric liquid crystal materials are cholesteric liquid crystals and/or nematic liquid crystals mixed with a twist agent. The second cholesteric liquid crystal materials can reflect multiple different colors. The second cholesteric liquid crystal materials can also reflect light with red, green and blue colors. The second cholesteric liquid crystal materials further include a pigment or dye capable of reflecting visible light having a wavelength of 400-800 nm. The above second solution, the mixture of the second cholesteric liquid crystal materials and monomers, includes liquid crystals with different twisted features. An ultraviolet exposure process is performed to induce the phase separation reaction to form multiple upper covers 62. In this step of the present invention, the device is directed exposed under ultraviolet light 64. The upper covers 62 form a macromolecule protective layer.

In FIG. 3E, multiple conductive materials 66 are coated on the upper covers 62. The conductive materials are black, light absorbing materials. The coating step is performed via a screening printing process, an inkjet printing process, a spin-coating process, a dipping process, a blade process and/or a printing process. When the coating step is completed, a color cholesteric liquid crystal display device with a stacked structure is also accomplished.

In the above first embodiment, when external light enters, the light matching the twisted feature is reflected while the light not matching the twisted feature passes. Hence, the reflectance is only 50%. Based on this structure, multiple bank structures are made in the present invention. Next, after a cholesteric liquid crystal material (left-twisted type) is printed to form the first cholesteric liquid crystal layer thereon, an ultraviolet exposure process is performed to form a cover layer. The cover layer is used to prevent the cholesteric liquid crystal material in the lower layer from being mixed with that in the upper layer. After the cover layer is formed, another cholesteric liquid crystal material (right-twisted type) is printed to form the second cholesteric liquid crystal layer thereon. Then, another ultraviolet exposure process is performed to form the upper covers that form a protective layer. The above two ultraviolet exposure processes can be different. Furthermore, the arrangement of cholesteric liquid crystal materials can have various combinative types of twisted features. For example, the three continuous portions have left-twisted feature and the next three continuous portions have right-twisted feature for increased reflectance.

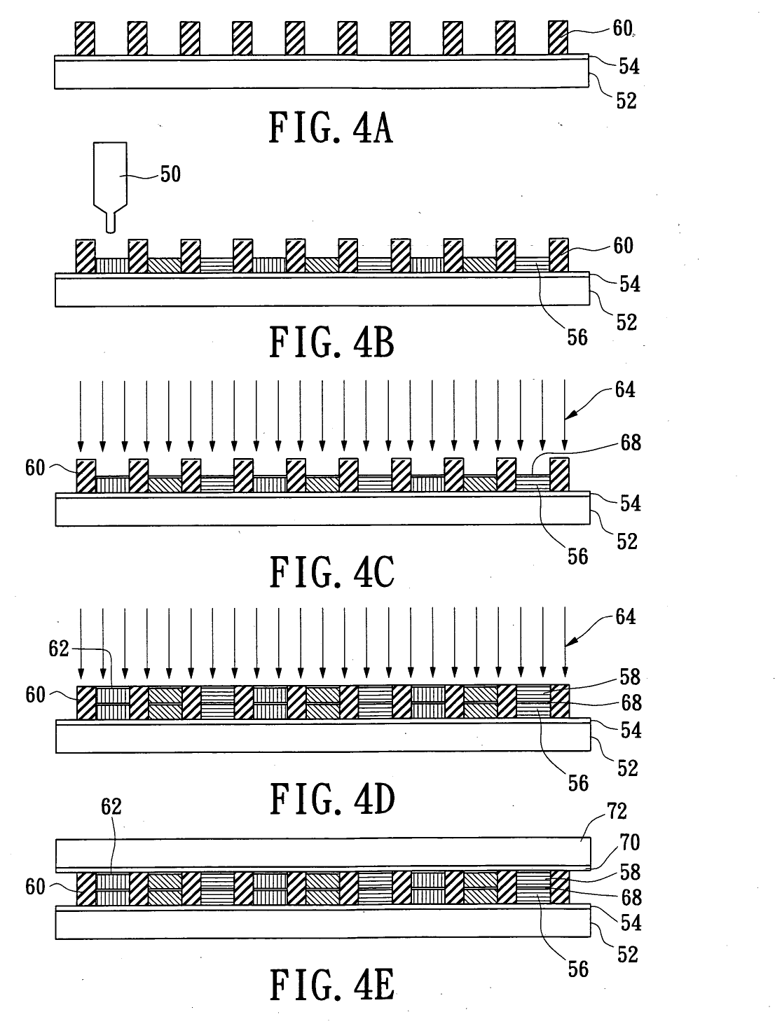

Reference is made to FIGS. 4A-E, which show schematic diagrams of a color cholesteric liquid crystal display device having a stacked structure and a dual-base structure manufactured via an inkjet printing process in accordance with the present invention. The manufacturing steps shown in FIGS. 4A-D are the same as those shown in FIGS. 3A-D of the first embodiment. In FIG. 4E, an upper base 72 having a second electrode layer 70 is provided on the upper covers. Thus, a color cholesteric liquid crystal display device having a stacked structure and two bases is formed.

The manufacturing of the present invention uses an inkjet printing process. The inkjet printing process can be used to define the display areas. Using the inkjet printing process can infuse the liquid crystal materials into display areas to provide the full-color effect. The twist agent can be left-twisted or right-twisted. If a right-twisted agent is added, light with wavelength matching the right-twisted feature is reflected. Moreover, the ingredient proportion of the twist agent affects the spectral band of the reflected light. The advantage of the inkjet printing process is that the positioning is easily controlled, whereby the materials to be infused can be infused into the display areas correctly. Furthermore, the present invention uses the bank structures to separate different areas and the ultraviolet exposure process to simplify the manufacturing steps and prevent color mixing.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A method for manufacturing a color cholesteric liquid crystal display device having a stacked structure, comprising:
making a plurality of bank structures on a first electrode layer of a lower base;
printing a first solution among the bank structures to form a plurality of first cholesteric liquid crystal layers, wherein the first solution is a mixture of first cholesteric liquid crystal materials and first monomers;
forming a plurality of cover layers on the first cholesteric liquid crystal layers;
printing a second solution into the bank structures to form a plurality of second cholesteric liquid crystal layers, wherein the second solution is a mixture of second cholesteric liquid crystal materials and second monomers;
forming a plurality of upper covers on the second cholesteric liquid crystal layers; and
coating a plurality of conductive materials on the upper covers.

2. The method as claimed in claim 1, wherein the lower base is made of glass or plastic.

3. The method as claimed in claim 1, wherein the first electrode layer includes an active driving circuit or a passive driving circuit.

4. The method as claimed in claim 1, wherein the first electrode layer is made of an inorganic conductive material or an organic conductive material.

5. The method as claimed in claim 1, wherein the bank structures are made via a lithography process, a die-casting process, a screening printing process, an inkjet printing process or a combination thereof.

6. The method as claimed in claim 1, wherein the bank structures contain a macromolecule material having a black pigment.

7. The method as claimed in claim 1, wherein the step of printing is performed via an inkjet printing process.

8. The method as claimed in claim 1, wherein the first cholesteric liquid crystal materials and the second cholesteric liquid crystal materials are mixtures of twist agents and Nematic liquid crystals.

9. The method as claimed in claim 1, wherein the first cholesteric liquid crystal materials and the second cholesteric liquid crystal materials include multiple cholesteric liquid crystals capable of reflecting different colors.

10. The method as claimed in claim 1, wherein the first cholesteric liquid crystal materials and the second cholesteric liquid crystal materials reflect visible light having a wavelength of about 400-800 nm.

11. The method as claimed in claim 1, wherein the first solution and the second solution have different twisted features.

12. The method as claimed in claim 1, wherein the first cholesteric liquid crystal materials and the second cholesteric liquid crystal materials have a pigment or dye.

13. The method as claimed in claim 1, wherein the first cholesteric liquid crystal materials and the second cholesteric liquid crystal materials have various combinative types.

14. The method as claimed in claim 1, wherein the upper covers are formed as a macromolecule protective layer via ultraviolet exposure.

15. The method as claimed in claim 1, wherein the step of coating is performed via a screening printing process, an inkjet printing process, a spin-coating process, a blade process, a printing process, or a combination thereof.

16. The method as claimed in claim 1, wherein the conductive materials are black, light absorbing materials.

17. The method as claimed in claim 1, wherein when the step of printing the first solution is performed, a color single-layer cholesteric liquid crystal display device is formed.

18. The method as claimed in claim 1, wherein the first electrode layer of the lower base is further coated with an alignment layer.

19. The method as claimed in claim 18, wherein the alignment layer is made of polyvinyl alcohol, polyimide, aramid, nylon, silica, micro-grooves or lecithin.

20. A color cholesteric liquid crystal display device having a stacked structure, comprising:
an lower base having a first electrode layer;
a plurality of bank structures distributed over the lower base;
a plurality of first cholesteric liquid crystal materials provided among the bank structures;
a plurality of cover layers on the first cholesteric liquid crystal materials;
a plurality of second cholesteric liquid crystal materials provided on the cover layers; and
a plurality of upper electrodes distributed on the cover layers.

21. The device as claimed in claim 20, further comprising an alignment layer coated on the first electrode layer of the lower base.

22. The device as claimed in claim 20, wherein the first electrode layer is made of an inorganic conductive material or an organic conductive material.

23. The device as claimed in claim 20, wherein the bank structures are made of a macromolecule material.

24. The device as claimed in claim 23, wherein the macromolecule material has a pigment or dye.

25. The device as claimed in claim 20, wherein the first cholesteric liquid crystal materials and the second cholesteric liquid crystal materials further contain a pigment or dye.

26. A color cholesteric liquid crystal display device having a stacked structure and a dual-base structure, comprising:
a lower base having a first electrode layer;
a plurality of bank structures formed on the lower base;
a plurality of first cholesteric liquid crystal materials provided among the bank structures;
a plurality of cover layers on the first cholesteric liquid crystal materials;
a plurality of second cholesteric liquid crystal materials provided on the cover layers; and
a second electrode layer formed on the cover layers.

27. The device as claimed in claim 26, further comprising an alignment layer coated on the first electrode layer of the lower base.

28. The device as claimed in claim 26, further comprising an upper base provided on the second electrode layer.

29. The device as claimed in claim 26, wherein the first electrode layer and the second electrode layer are made of an inorganic conductive material or an organic conductive material.

30. The device as claimed in claim 26, wherein the bank structures are made of a macromolecule material.

31. The device as claimed in claim 30, wherein the macromolecule material has a pigment or dye.

32. The device as claimed in claim 26, wherein the first cholesteric liquid crystal materials and the second cholesteric liquid crystal materials further contain a pigment or dye.

33. The device as claimed in claim 26, wherein the second electrode layer is made of a conductive material.

34. The device as claimed in claim 33, wherein the conductive material is a black, light absorbing material.
